(19) United States
(12) Patent Application Publication
(10) Pub. No.: US 2026/0081365 A1
(43) Pub. Date: Mar. 19, 2026

(54) POWER LINE CLAMP WITH SPRING LOADED TAP CONNECTOR

(71) Applicant: Hubbell Incorporated, Shelton, CT (US)

(72) Inventor: Pieter Jere Beckman, Nottingham, NH (US)

(21) Appl. No.: 19/331,383

(22) Filed: Sep. 17, 2025

Related U.S. Application Data
(60) Provisional application No. 63/695,470, filed on Sep. 17, 2024.

(51) Int. Cl. H01R 4/30; H01R 4/36; H01R 11/05; H02G 1/02

(52) U.S. Cl. CPC H01R 4/304; H01R 4/305; H01R 4/366; H01R 11/05; H02G 1/02

(57) ABSTRACT

An electrical connector includes a clamp body having a base, a side portion, an upper portion, and a boss. The clamp body defines a cable groove configured to receive a primary conductor and an aperture for receiving a secondary conductor. A primary fastener is movably connected to the clamp body. A keeper is connected to the clamp body and moveable with the primary fastener to secure the primary conductor in the cable groove. A secondary fastener is configured to secure the secondary conductor in the aperture. The clamp body is configured to provide a spring force to the secondary conductor when engaged with the secondary fastener.

### RELATED APPLICATION(S)

This application is based on U.S. Provisional Application Ser. No. 63/695,470, filed Sep. 17, 2024, the disclosure of which is incorporated herein by reference in its entirety and to which priority is claimed.

### FIELD

Various exemplary embodiments relate to an electrical connector for a utility power line.

### BACKGROUND

A power line clamp connector is used to make a permanent or temporary connection to an overhead power distribution line. Some examples of power line clamp connectors include hotline clamps and piggyback clamps which are used to connect a tap line to a primary conductor. These types of clamps can be used to hold a tap line in position with a main conductor while a more permanent connection is made. Typically, these connectors are installed by a lineman using a hot stick.

### SUMMARY

In certain configurations, an electrical connector includes a clamp body configured to provide a spring force to a secondary conductor in addition to the force applied by a fastener.

In certain configurations, an electrical connector includes a clamp body having a base, a side portion, an upper portion, and a boss. The clamp body defines a cable groove configured to receive a primary conductor and an aperture for receiving a secondary conductor. A primary fastener is movably connected to the clamp body. A keeper is connected to the clamp body and moveable with the primary fastener to secure the primary conductor in the cable groove. A secondary fastener is configured to secure the secondary conductor in the aperture. The clamp body is configured to provide a spring force to the secondary conductor when engaged with the secondary fastener.

In certain configurations, an electrical connector includes a clamp body having a base, a side portion, an upper portion, and a boss. The clamp body defines a cable groove configured to receive a primary conductor and an aperture for receiving a secondary conductor. A primary fastener is movably connected to the clamp body. A keeper is connected to the clamp body and moveable with the primary fastener to secure the primary conductor in the cable groove. A secondary fastener is configured to secure the secondary conductor in the aperture. The boss includes a cantilevered rear wall receiving the secondary fastener.

In certain configurations, an electrical connector includes a clamp body having a base, a side portion, an upper portion, and a boss. The clamp body defines a cable groove configured to receive a primary conductor. The boss includes a lower wall extending from the side portion. A rear wall extends from the lower wall and an aperture in the rear wall is configured to receive a secondary conductor. A primary fastener is movably connected to the clamp body. A keeper is connected to the clamp body and moveable with the primary fastener to secure the primary conductor in the cable groove. A secondary fastener is configured to secure the secondary conductor in the aperture. The rear wall is configured to provide a spring force to the secondary conductor when engaged with the secondary fastener.

### BRIEF DESCRIPTION OF THE DRAWINGS

The aspects and features of various exemplary embodiments will be more apparent from the description of those exemplary embodiments taken with reference to the accompanying drawings.

FIG. 1 is a perspective view of an embodiment of an electrical connector.

FIG. 2 is a side view of FIG. 1.

FIG. 3 is a side, magnified view of the cable groove of the connector.

FIG. 4 is a perspective, magnified view of the cable groove of FIG. 3.

FIG. 5 is a side view of an embodiment of an electrical connector.

FIG. 6 is a top perspective view of the clamp of FIG. 5.

FIG. 7 is a bottom perspective view of the clamp of FIG. 5.

FIG. 8 is a partial side view of the clamp of FIG. 5.

FIG. 9 is a partial top view of the clamp of FIG. 5.

### DETAILED DESCRIPTION OF EXEMPLARY EMBODIMENTS

Various exemplary embodiments are directed to an electrical connector configured to electrically connect a first electrical conductor to a second electrical conductor. In certain configurations the electrical conductors can be utility line power conductors. The first conductor can be a main conductor such as a run cable, or feeder cable conductor for example. The second conductor can be a tap wire, or tap line conductor for example. However, it should be understood that alternative embodiments may accommodate any combination of conductor types and/or sizes.

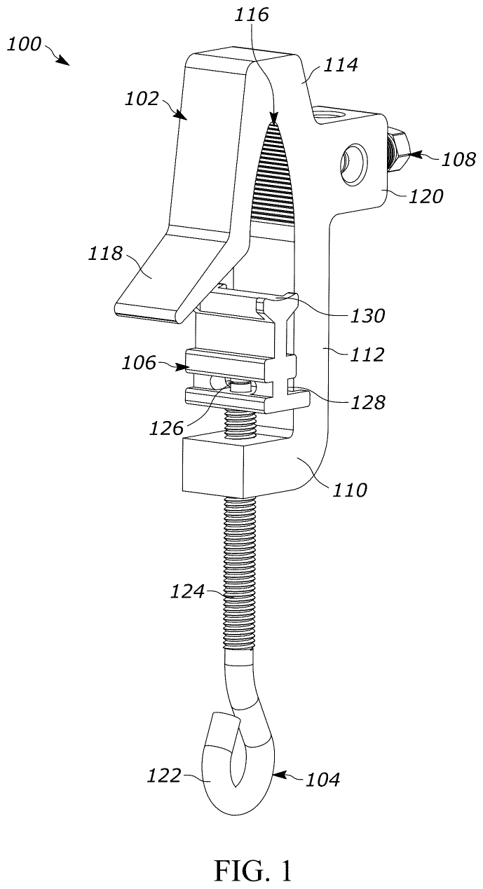

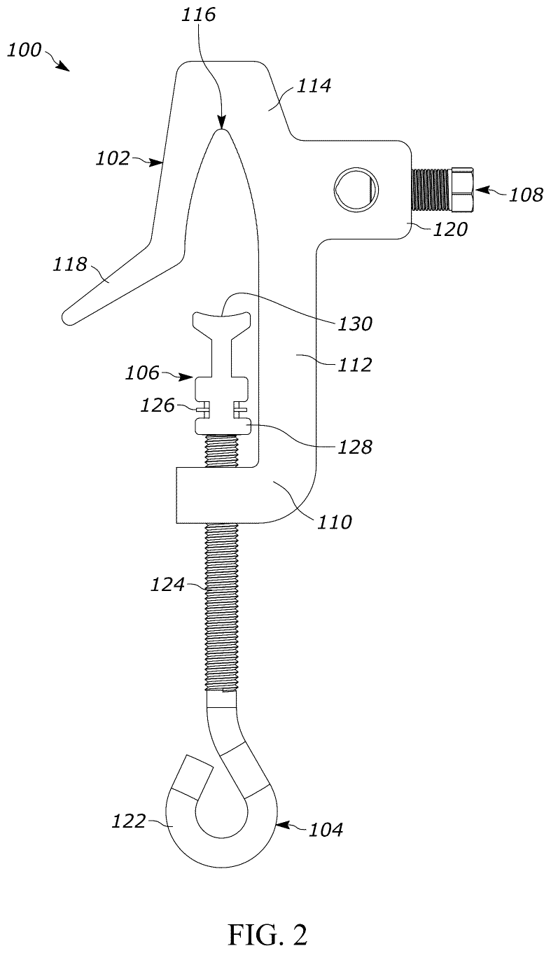

FIG. 1 shows an exemplary embodiment of a connector 100 having a hot line clamp configuration. The connector 100 has a clamp body 102, a primary fastener 104, a keeper 106, and a secondary fastener 108. The hot line connector 100 is configured to receive a primary conductor and a secondary conductor in the clamp body 102 to make an electrical connection between the two conductors.

In various embodiments, the clamp body includes a base 110 with an aperture for receiving the primary fastener 104. A side portion 112 extends upwardly from the base 110. An upper portion 114 extends outwardly from the side portion 112 and defines a cable groove 116. The upper portion 114 can include a forward extension 118 which extends outwardly from the cable groove 116. The forward extension 118 can extend at an oblique angle away from the cable groove 116 and down toward the base 110.

A boss 120 extends from the rear of the upper portion 114. The boss 120 includes an aperture for receiving the secondary fastener and one or more apertures from receiving a secondary conductor. The secondary or tap conductor can be inserted into one of the openings in the boss 120 and the secondary fastener 108 can be tightened to secure the secondary conductor.

In certain configurations the primary fastener 104 includes an eye 122 and a threaded portion 124. The keeper 106 is connected to the end of the primary fastener 104 by a retaining ring 126. In an exemplary operation, the eye 122 can be engaged by a hot stick and the primary fastener 104 rotated to move the keeper 106 relative to the cable groove 116 to retain a conductor. The keeper 106 can be rotatably connected to the primary fastener 104 so that rotational position of the keeper 106 remains relatively steady with respect to the primary fastener 104 during rotation. The keeper 106 can include a keeper body 128 having one or more projections. The upper projection can include a curved outer surface 130 for receiving a conductor.

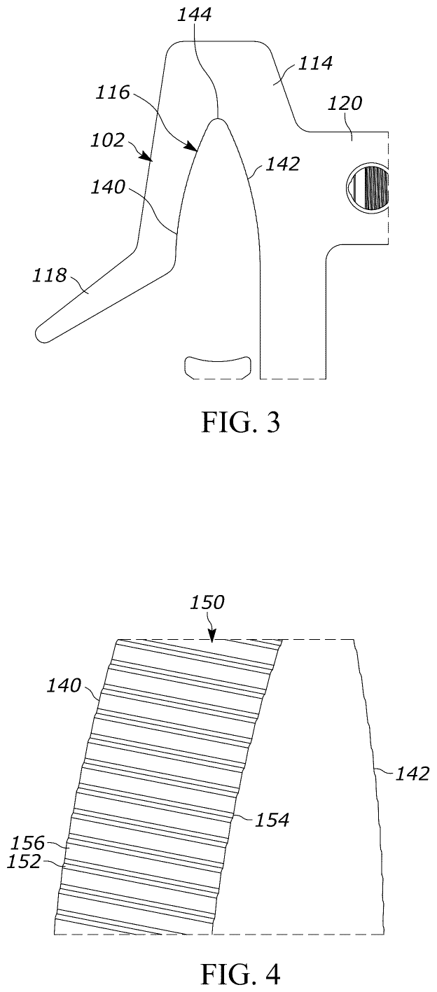

The cable groove 116 is configured to receive various sized primary conductors. As best shown in FIG. 3, the cable groove 116 can include an outer wall 140, an inner wall 142, and an upper wall 144. In certain configurations, the outer wall 140, inner wall 142, and upper wall 144 can have an arched configuration. In the illustrated embodiment the cable groove has a substantially ogival (aka gothic) arch configuration with a curving outer wall 140, inner wall 142, and a pointed upper wall 144. Although an ogival arch is shown, various other arched configurations can be used with different curved sides and other crown or point configurations. For example, other embodiments can utilize a segmented, semicircular, trefoil, basket, parabolic, tudor, rampant, acute, or ogee arch configuration can be used.

Typical clamps utilize a V-shaped cable groove with substantially rectilinear sides meeting in a point. The arched configuration provides improvements of the V-shaped design in that the curvature of the arch can help form enhanced contact with the conductor when pressed into the cable groove 116. The arched configuration can also be easier to release the conductor, as a V-shaped groove can require more force to deform and seat the conductor during installation. The arched configuration can also allow for a greater range of conductors to be used. For example, various embodiments of hot line connectors can be configured to operate in a small range, with a main conductor range of #4 to 4/0 ACSR or a diameter of 0.232 to 0.563 inches and a tap conductor range of #8 to 2/0 AAC or a diameter of 0.128 to 0.414 inches, a medium range, with a main conductor range of 1/0 to 795 AAC or a diameter of 0.368 to 1.027 inches or a tap conductor range of #8 to 4/0 AAC or a diameter of 0.128 to 0.522 inches, and a large range, with a main conductor range of 636 to 1033.5 ACSR or a diameter of 0.918 to 1.245 inches and a tap conductor range of #8 to 4/0 AAC or a diameter of 0.128 to 0.522 inches.

In various exemplary embodiments, the cable groove 116 can include a plurality of teeth 150 as best shown in FIG. 4. Each of the teeth 150 can have a first side 152, a peak 154, and a second side 156. The teeth can have an angled, stepped configuration so that the first side 152 is shorter than the second side 156 and the peak 154 is at a downward, oblique angle relative to the outer wall 140 and inner wall 142. This configuration can allow the teeth 150 to better grip the primary conductor and provide abrasion during insertion that facilitates a better connection, while also allowing for easier removal of the primary conductor if needed.

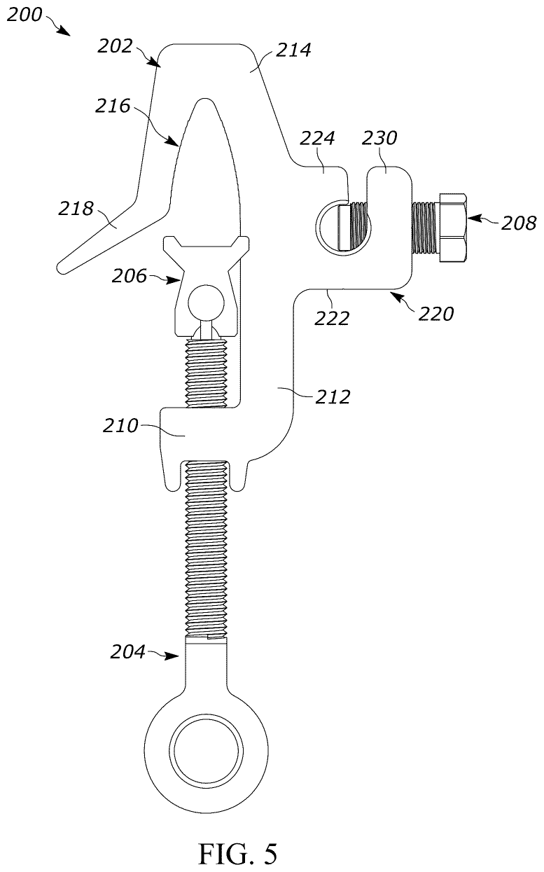

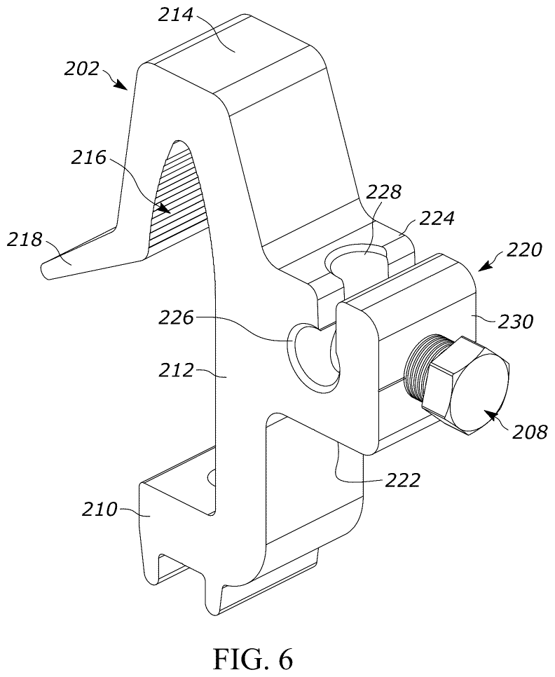

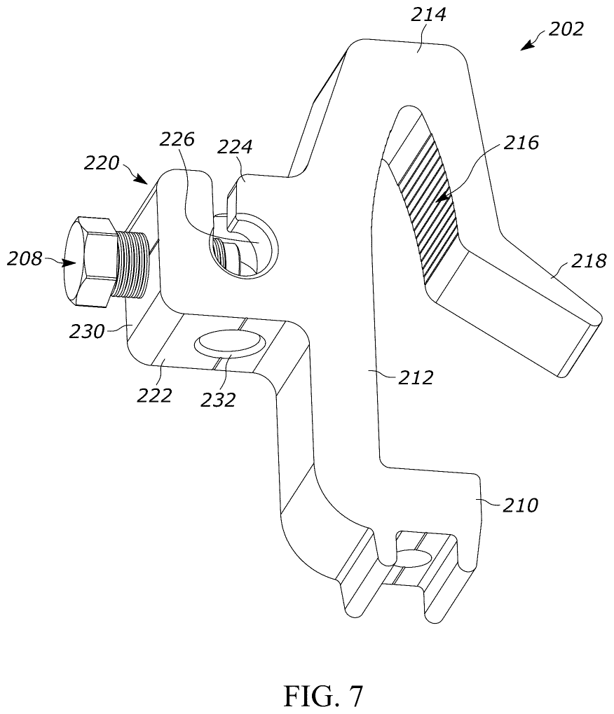

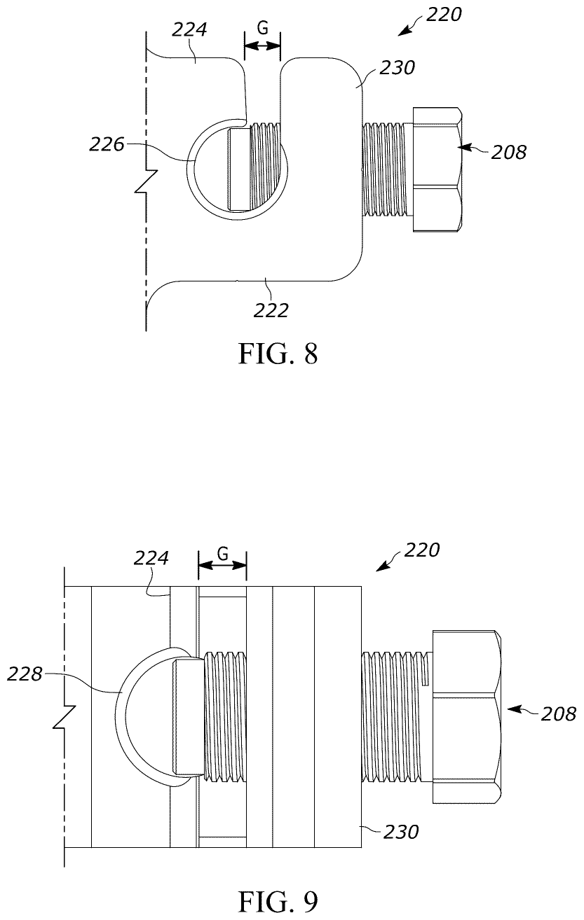

FIG. 5 shows another exemplary embodiment of a connector 200 having a similar configuration as a hot line clamp with a clamp body 202, a primary fastener 204, a keeper 206, and a secondary fastener 208. The clamp body 202 includes a cable groove 216 with an arched configuration.

In various embodiments, the clamp body 202 includes a base 210 with an aperture for receiving the primary fastener 204. The base 210 can include a set of protrusions extending below the aperture to act as an interface with a hot stick to prevent rotation of the clamp body 202 during installation. A side portion 212 extends upwardly from the base 210. An upper portion 214 extends outwardly from the side portion 212 and defines a cable groove 216. The upper portion 214 can include a forward extension 218 which extends outwardly from the cable groove 216. The forward extension 218 can extend at an oblique angle away from the cable groove 216 and down toward the base 210.

A boss 220 extends from the rear of the upper portion 214. The boss 220 includes an aperture for receiving the secondary fastener 208 and one or more apertures from receiving a secondary conductor. The secondary or tap conductor can be inserted into one of the openings in the boss 220 and the secondary fastener 208 can be tightened to secure the secondary conductor.

In certain configurations, the boss 220 includes a spring portion that is capable of providing a torque force to a clamped secondary conductor. For example, the boss 220 can be structured to provide a clamping force in addition to the secondary fastener 208 when a secondary conductor is installed. This clamping force can be from a cantilevered portion that creates a moment when the secondary fastener 208 is tightened that provides an additional spring force to the secondary fastener 208.

In the illustrated embodiment, the boss 220 includes a lower wall 222 extending from the side portion 212 of the clamp body 202. The lower wall 222 can extend along the width of the side portion 212 and extend outwardly from the clamp body 202. A lower opening 232 can be provided in the lower wall 222 for receiving the secondary conductor in a vertical orientation. The lower opening 232 can have a chamfered surface to provide easier insertion of the secondary conductor.

One or more upper arms 224 extend from the side portion 212 spaced from the lower wall 222. The upper arms 224 can include a curvilinear lower surface 226 that transitions to the lower wall 222, defining a curved opening in the side of the boss 220. The curved opening can have a chamfered leading edge. In the illustrated embodiment the curved opening is substantially circular, although other curved configurations can be used. The curved openings 226 can receive a secondary conductor in a horizontal orientation.

The upper arms 224 can also be connected by a curvilinear upper surface 228. In the illustrated embodiment the curved upper surface 228 is substantially circular, although other curved configurations can be used. The upper surface 228 can combine with the lower opening 232 to receive a secondary conductor in a vertical orientation. The upper surface 228 can have a chamfered leading edge. The upper arms 224 can be any other types of projections extending from the clamp body 202 and in certain configurations the no projections can be used.

A rear wall 230 extends upwardly from the lower wall 222 in a direction away from the base 210. The rear wall 230 can include the opening for receiving the secondary fastener 208. The upper edge of the rear wall 230 can be rounded to help prevent corona buildup and discharge.

The rear wall 230 is spaced from the upper arms 224 to form a spring gap G between the upper arms 224 and the rear wall 230. The rear wall 230 therefore extends from the lower wall 222 in cantilevered fashion. The spring gap G allows the rear wall 230 to deflect relative to the side portion 212 of the clamp body 202. In certain configurations the spring gap G can be defined between the rear wall 230 and the side portion 212.

Conventional style conductor tap clamps can result in the loosening of the tap conductor over time due to material creep deformation. Materials will undergo creep deformation from clamping pressure, and common conductor materials (i.e. aluminum, copper) and multi strand conductors are more susceptible to creep than hard and solid materials. Elevated temperatures increase the potential for creep, and current carrying conductors experience elevated temperatures during use. When a conventional “bolt-and-hole” clamp bolt is torqued onto a conductor during installation, the clamping force will relax as the conductor material creeps, this relaxation will continue over time and temperature.

The boss 220 can provide a spring force during installation of the tap conductor. Tightening the secondary fastener 208 can cause deflection of the rear wall 230, widening the spring gap G. In turn, the rear wall 230 will provide a resilient spring force which will act to push the secondary fastener 208 tighter against the secondary conductor. This provides superior clamping force on the conductor over temperature and time and mitigates the risk of creep induced connector to conductor contact failure.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Unless specified or limited otherwise, the terms “mounted,” “connected,” “supported,” and “coupled” and variations thereof are used broadly and encompass both direct and indirect mountings, connections, supports, and couplings.

What is claimed:

1. An electrical connector comprising:
a clamp body having a base, a side portion, an upper portion, and a boss, the clamp body defining a cable groove configured to receive a primary conductor and an aperture for receiving a secondary conductor;
a primary fastener movably connected to the clamp body;
a keeper connected to the clamp body and moveable with the primary fastener to secure the primary conductor in the cable groove; and
a secondary fastener configured to secure the secondary conductor in the aperture,
wherein the clamp body is configured to provide a spring force to the secondary conductor when engaged with the secondary fastener.

2. The electrical connector of claim 1, wherein the boss includes a cantilever rear wall receiving the secondary fastener.

3. The electrical connector of claim 2, wherein the boss includes an upper arm spaced from the rear wall.

4. The electrical connector of claim 2, wherein the rear wall deflects when clamping the secondary fastener to the secondary conductor.

5. The electrical connector of claim 1, wherein rear wall extends from a lower wall extending from the side portion.

6. The electrical connector of claim 1, wherein the boss includes a lower opening for receiving the secondary conductor in a vertical orientation and a pair of side openings for receiving the secondary conductor in a vertical orientation.

7. An electrical connector comprising:
a clamp body having a base, a side portion, an upper portion, and a boss, the clamp body defining a cable groove configured to receive a primary conductor and an aperture for receiving a secondary conductor;
a primary fastener movably connected to the clamp body;
a keeper connected to the clamp body and moveable with the primary fastener to secure the primary conductor in the cable groove; and
a secondary fastener configured to secure the secondary conductor in the aperture,
wherein the boss includes a cantilevered rear wall receiving the secondary fastener.

8. The electrical connector of claim 7, wherein the boss includes a pair of upper arms spaced from the rear wall.

9. The electrical connector of claim 8, wherein the upper arms are connected by a curved upper surface configured to receive the conductor in a vertical orientation.

10. The electrical connector of claim 7, wherein rear wall extends from a lower wall.

11. The electrical connector of claim 10, wherein the lower wall includes an opening for receiving the secondary conductor.

12. The electrical connector of claim 7, wherein the boss includes a pair of openings configured to receive the secondary conductor in a horizontal orientation.

13. The electrical connector of claim 7, wherein the rear wall has a rounded upper edge.

14. An electrical connector comprising:
a clamp body having a base, a side portion, an upper portion, and a boss, the clamp body defining a cable groove configured to receive a primary conductor, the boss including a lower wall extending from the side portion, a rear wall extending from the lower wall, and an aperture in the rear wall for receiving a secondary conductor;
a primary fastener movably connected to the clamp body;
a keeper connected to the clamp body and moveable with the primary fastener to secure the primary conductor in the cable groove; and
a secondary fastener configured to secure the secondary conductor in the aperture,
wherein the rear wall is configured to provide a spring force to the secondary conductor when engaged with the secondary fastener.

15. The electrical connector of claim 14, wherein the rear wall deflects away from the clamp body when the secondary fastener is tightened on the secondary conductor.

16. The electrical connector of claim 14, wherein the boss includes a pair of upper arms spaced from the rear wall.

17. The electrical connector of claim 16, wherein the upper arms are connected by a curved upper surface configured to receive the conductor in a vertical orientation.

18. The electrical connector of claim 16, wherein the upper arms include a curved transition to a lower wall.

19. The electrical connector of claim 14, wherein the boss includes a lower opening for receiving the secondary conductor in a vertical orientation and a pair of side openings for receiving the secondary conductor in a vertical orientation.

20. The electrical connector of claim 14, wherein the rear wall includes a rounded upper edge.
